(19) United States
(12) Patent Application Publication
(10) Pub. No.: US 2005/0138139 A1
(43) Pub. Date: Jun. 23, 2005

(54) System and method for distribution and tracking of digital content

(76) Inventors: Naveen K. Jain, Novato, CA (US); Erik Bielefeldt, Stanford, CA (US); Mark J. Ehlert, Calgary (CA); Craig N. Wood, Berkeley, CA (US)

Correspondence Address: Hugh R. Kress, Suite 1800, 5718 Westheimer, Houston, TX, 77057, US

(21) Appl. No.: 10/745,180

(22) Filed: Dec. 23, 2003

(51) Int. Cl. G06F 15/173; G06F 15/16

(52) U.S. Cl. 709/217; 709/225

(57) ABSTRACT

A system and method for distribution of content is disclosed in which the content in the form of a content record is distributed from a content originator through a series of intervening recipients of copies of the content record. Each recipient of a copy of a content record is capable of making further copies for distribution to other recipients. Each content record includes certain tracer information for tracking the distribution of the content and preferably uniquely identifying each recipient along the distribution chain.

### FIELD OF THE INVENTION

The present invention relates generally to the field of computing, and more particularly to systems and methods for distribution and tracking of digital content.

### BACKGROUND OF THE INVENTION

As used herein, the term “content” shall be defined and construed in the broadest possible sense to encompass essentially any compilation of data in whatever form, including without limitation, computer data files of all kinds. Examples of content-include without limitation, computer graphics files of various known file types and formats (e.g., .jpg, .gif, .pdf, .tif, etc . . . ), computer sound files of various known file types and formats (e.g., .wav, .mp3, etc . . . ), text-based computer documents of various known file types and formats (e.g., .doc, .wpd., .rtf, .txt, etc . . . ), computer data files, computer applications, and so on. Digital content in the form of discrete “files” can be of any size, from one to millions or billions or more of digital bits.

Similarly, as used herein, the term “stored” as applied to digital content shall be defined and construed in the broadest possible sense, to encompass any instance where digital content is tangibly embodied, for any period of time (i.e., either “permanently” or “temporarily”) in any type storage medium, including, without limitation, on a magnetic tape or disk, on a compact disc (“CD”), CD-ROM, CD RAN, DVD, and computer memory (including without limitation, read-only memory (“ROM”), any type of random-access memory (“RAM”)), or any other digital content storage medium presently known or to be developed in the future.

Also, as used herein, the term “distribution” as applied to digital content shall be defined and construed in the broadest possible sense to encompass any instance wherein digital content is communicated in any manner from one location to another. “Distribution” shall be used and construed to apply to any manner whatsoever for communication of digital content, including without limitation, communication of digital content over a network, transmission over a cabled or wireless connection from one storage medium to another, physical transport of a copy of digital content tangibly embodied in a storage medium (e.g., stored on a disk).

Finally, as used in this disclosure, the term “network” shall be defined and construed in the broadest possible sense, to encompass any mechanism by which digital content can be sent from one physical location to another. The term “network” can be used to describe all presently known types of networks, including without limitation local area networks (LANs) to which two or more computers have access, wide-area networks, the Internet, and so on. Moreover, the term “network” will include interconnections of two or more otherwise separate networks (which is, essentially, what the Internet is).

Using the foregoing broadest constructions, distribution of digital content can take on a great many forms. Physically transferring any tangible storage medium (e.g., CD, CD ROM, DVD, etc . . . ) containing digital data (e.g., an audio file, data) from one location to another would constitute an instance of distribution of digital content. Causing digital data of any sort to be communicated over a network, such as the Internet, from one stored location to another would constitute an instance of distribution of digital content.

Regardless of what type of digital content being considered, when considered broadly as discussed above, there are an essentially limitless number of instances where it may be desired to communicate digital content from one storage location to another, i.e., to distribute digital content.

One example (by no means the only) of distribution of digital content lies in the context of the distribution of digital copies of artistic works, such as music. Digital distribution of digital forms of musical works has in recent times been the subject of much debate, owing to the potential for abuses in the form of copyright infringement. Nevertheless, there are almost limitless legitimate and legal instances where the distribution of many types of digital content may be desirable.

### SUMMARY OF THE INVENTION

In view of the foregoing and other considerations, the present. invention is directed to a method and system for distribution of content across a potentially vast base of recipients.

In accordance with one aspect of the invention, a means is provided through hardware and software for low-cost distribution of content that is powered by users who are willing to transfer and distribute freely available media content, software, electronic books or other electronic goods. In accordance with one aspect, the invention removes the burden of distribution from a single distribution center, or multiple fixed distribution centers, and spreads the burden across many individual distribution entities. Recipients receiving the distribution will transfer and distribute the content to other users based on the natural tendency to share, among other possible incentives. The invention improves on existing systems by enabling the content provider to update the content being distributed at any time as a means to reward consumers for transferring the distribution, or to provide up to date versions of content prior to transfer to other users. Additionally, the mechanism will allow advertisers and marketers the ability to identify and market new content to users who transfer and distribute a significant amount of media.

In one embodiment, the invention consists of a client application and two server applications: a Registry, which records user information and transfer activities, and a Content Server, which provides updates to content distributed in accordance with the.constructs of. the present invention. Server applications communication over a network when performing various activities, and each replication of the content that may be distributed can present the content it contains to the user, update the content it contains, transfer itself to another storage Iocation for distribution to other users, and communicate user and transfer information to the Registry.

In a preferred embodiment, multiple copies of any given content record will be in existence on a number of client machines. Each individual copy of a content record will can be considered an instance of the content record. Each instance created by a given instance can be considered as a child of the given instance, and the instance which created the given instance can be considered the parent of the given instance. Similarly, the parent, parent of the parent, and so on, can be considered ancestors of the given instance, and children, children's children, and so on, can be considered descendants of the given instance.

Each instance of a content record preferably consists of the following components:
1. Digital content to present to the user.
2. A means for the content record to communicate with Registry to download or update the content on the content record. This content is preferably stored on the client/recipient machine.
3. An Identification Number (Distribution ID) identifying this instance.
4. A means and protocol for communicating with The Registry over a network to register and report on the user's information (demographics, marketing preferences, etc.).and the user's activities.
5. A means of storing user and transfer information for this instance locally on the client/recipient machine.
6. Information about ancestors of this instance. Every instance will contain information about its ancestors—specifically the users of the ancestors and the instances created by those ancestors. This will allow the. distribution history leading to any particular instance to be known from that instance.
7. A means for the user to create a new instance of the content record by transferring the content record to another storage location.

In one embodiment, a content record communicates with the server over a network, such as the Internet. If the network is inaccessible at a given time or in a given circumstance, the recipient of an instance content record may access content contained in this instance and perform transfers without communicating with the servers. In case the content record cannot contact the servers, information about the user and any transfer activities are stored by a given instance, as well as any children of this instance, and can later be uploaded to the Registry by this instance, by a descendant of this instance, or both.

A content record is preferably capable of contacting the Server to receive updates to the content contained in the content record. Additional content can be downloaded and configured from the Server and made available to the user. Content downloaded from the Server can reside on the client machine. This additional content may be included in any child instances when the content record is transferred. Content updates may be done in response to a variety of circumstances: passage of a specified amount of time, every time the content record is accessed or executed, or in response to user actions (user requests updates, or user may receive updates as a reward after distributing a certain number of instances of the content record to others).

Preferably, the Distribution ID data for a given content record will be unique across all instances of the content record except perhaps those initially distributed from the content originator, which may be initialized with a master ID (Originator ID). The ID data allows each instance to be identified and enable accurate tracking of the distribution process and the user base.

In various embodiments, the invention may be used in the distribution of content in a variety of applications, including:
Promotion and distribution of music content
Promotion and distribution of multimedia content
Promotion and distribution of video content
Promotion and distribution of software
Promotion and distribution of electronic book content
Promotion and distribution of government policy
Promotion and distribution of advertisements
Promotion and distribution of product information
Promotion and distribution of safety information
Promotion and distribution of electronic currency
Promotion and distribution of educational content and information

In various embodiments, the invention reduces the material and labor costs of distributing content to a large user base. Instead of creating a large number of copies of the content on physical media and delivering these to the intended audience, a lesser number of copies may be distributed to an initial user base and these users will provide the labor and materials necessary to distribute to the larger user base. This can significantly reduce labor costs, the cost of manufacturing the physical media, and potential shipping and distribution costs.

The invention also allows content to be updated at any point along the duration of a distribution cycle, increasing the relevance and effectiveness of the content. Content distributed traditionally on physical media from central distribution centers may quickly become outdated over time. Updating content can be very expensive, and can pose logistical challenges. The invention provides a low cost and almost instantaneous means of updating content both on new distributions and current distributions that are already in the user's hands. Furthermore, updated content may be targeted more accurately based on knowledge of a given user kept in the registry.

The invention also solves the problem of distributing freely available or promotional content to users in a manner in which users will perceive that they are receiving the content from their peers as opposed to receiving promotional product from a conglomerate with clear profit motive. By encouraging users to transfer and distribute themselves, users will feel more inclined to share the content. Similarly, content recipients will feel that the content they receive is from a more personally relevant source.

The invention also solves the problem of identifying users who distribute content to other users at a higher rate. By tracking transfer, usage, and distribution, the invention can systematically identify these users- and enable marketers to selectively provide content or content updates for future distribution to these users.

Other features of the invention include:
Fast, easy to use, user to user distribution of content;
The ability to upgrade content or product mid-distribution cycle without restarting the distribution process;
The ability to identify and target early adopters and high distribution users for future advertising campaigns, products, or content distribution.
Tracking user base, user profiles, user activities, and distribution patterns of electronic content or product.

### BRIEF DESCRIPTION OF THE DRAWINGS

The foregoing and other features and aspects of the subject invention will be best understood with reference to a detailed description of specific embodiments of the invention, which follow, when read in conjunction with the accompanying drawings, wherein:

FIG. 1 is a block diagram of a distribution infrastructure upon which the distribution process in accordance with one embodiment of the invention may be practiced;

FIG. 2 is a diagram of a content record in accordance with one embodiment of the invention;

FIG. 3 is a flow diagram showing steps in the distribution process in accordance with one embodiment of the invention; and

FIG. 4 is a diagram showing a distribution of digital content in accordance with one embodiment of the invention.

### DETAILED DESCRIPTION OF SPECIFIC EMBODIMENTS OF THE INVENTION

The disclosure that follows, in the interest of clarity, does not describe all features of actual implementations. It will be appreciated that in the development of any such actual implementation, as in any such project, numerous engineering and design decisions must be made to achieve the developers' specific goals and subgoals, which may vary from one implementation to another. Moreover, attention will necessarily be paid to proper engineering and programming practices for the environment in question. It will be appreciated that such a development effort might be complex and time-consuming, but would nevertheless be a routine undertaking for those of ordinary skill in the relevant field.

A specific embodiment of the invention, that is to say, a specific contextual application of the invention, is described herein for the purposes of illustrating the salient features of the invention as a whole. It is to be understood, and believed that it will be readily understood, by those of ordinary skill in the art, that the practice of the present invention is by no means limited to the particular context(s) addressed in the present disclosure. It is specifically asserted that the present invention is not at all limited to application in the context of distributing musical works in a digital format, though as noted above this is believed to be one application for which the present invention may be particularly well-suited.

The Client Program:

In one embodiment, the invention consists of an integrated marketing and distribution system (“the Promo”) whereby a single content record associated with a Promo includes, in a preferred embodiment:
1. Promotional marketing material (content) to present to any recipient of a copy of the content record.
2. Identification information associated with (and preferably unique to each copy). An identification number (ID) identifying each copy of a content record as each copy is propagated in accordance with the constructs of the present invention. Such identification information may take the form of a “header,” “tag” or otherwise associated compilation of information containing information relating to the origin and history of the content as pertaining to the particular copy in question.
3. A means for the content record establish communication with at least one server (“a Registry”) to register and report on the recipient base and the recipients' further replication and distribution activities;
4. A means for recipients to replicate and distribute instances of the content record in the form of its content file along with associated identification as outlined herein.
   Promotional Marketing Material

A content record created and distributed in accordance with the presently preferred embodiment of the invention (a Promo) can contain any form of media and/or programs presumably intended to market the content to consumers. As noted previously, the content may include any combination of audio, video, or other media elements as well as promotional programs and demonstrations for the recipients.

An Identification Number (ID) Uniquely Identifying the Copy of the Content Record

An ID associated with a copy of a content record -distributed in accordance with the constructs of the present invention is preferably unique across all instances of the content record, perhaps excepting those initially distributed from the originator of the content. The ID will allow accurate tracking of the distribution process and the user base.

A Protocol for Recipients of Content Records to Communicate with the Registry

A content record preferably is enabled to communicate with the Registry via network contact (e.g, via the Internet, a local area network (LAN) or wide-area network (WAN), for example) to register the users/recipients of instances of the content record and information associated with such users/recipients. The content record will preferably prompt users to provide demographic and other identifying information (e.g., names and addresses) as well as other demographic and marketing data (age, gender, market preferences, and so on). Such user data will preferably be sent to the Registry and recorded there to track the user base of the Promo. The ID of the particular instance of the content record is also preferably posted to the server.

A Means for the User to Replicate the Content Record

In accordance with one aspect of the invention, a content record preferably includes replication software that is adapted to generate copies of the Promo and package them (digitally) for distribution to others. Examples of such replication software include CD or DVD reproduction (“burning”) applications. Preferably, each copy of the content record will be different from the originating copy in the following ways:
1. Copies preferably contain a new ID identifying the new copy;
2. Copies preferably contain a record of who has copied the content record in the past;
3. Such record preferably will include information identifying prior associated users (i.e. the information posted to the registry regarding predecessor copies of the content record), information on when previous users copied the content record, the number of copies of the content record made, and the respective users' IDs. Such historical information preferably will include information on all users in the chain of distribution up to the current user. For example, if User 1 receives a copy of the content record from the originator of the content and makes 3 copies, the first copy will have User 1's profile information, the ID of the copy of the content record that User 1 is using, and the number and IDs of copies made from User 1's copy of the content record (1 copy). The second copy will preferably have all the same data except that the data reflecting the number of copies (“generations” of copies) will be 2. When this copy is passed on to User 2, and User 2 makes a copy, the copy produced will have all User 1's info (profile, IDs, and number (generations) of copies), as well as the same data for User 2. In this manner, the complete distribution history for any particular instance of the content record is contained on each copy. In one embodiment, certain sensitive data may be encrypted in the content record.
4. In one embodiment of the invention, content in a content record may be changed at the will of the originator of the content to reflect updated material that is downloaded from the Registry (central server). The replication software may poll the Registry (central server) and update the marketing material if needed. In this manner, the content record can always have up-to-date material each time it is copied.
   Business Methodology:

The overall business methodology underlying the present invention is summarized as follows:
First and foremost is the objective of recipients to receive content records from originators of digital content. Media can either be downloaded over the network or received on physical digital media. Content records preferably contain:
   1. Content. As noted above, this may include audio, video, and other multimedia content, as well as promotional computer software to promote the subject matter of the Promo;
   2. A means of registering with the Registry as a promoter of the content;
   3. A means of replicating the content record to pass on to peers;
   4. Instructions on distributing the replicas to peers;
   5. A unique serial number identifying the exact copy of the content record;
   6. The distribution history of the content record (who has duplicated the content records, at what times, to whom they distributed it, etc . . . )

Second is the objective of providing a mechanism by which content originators 11 can associate with the Registry as a promoter of the content. Content originators preferably can provide basic information to identify themselves and optional demographic and marketing information (sex, age, occupation, etc.) to be associated with the Promo. When accessed by a recipient, the content record will preferably attempt to contact the Registry and register users and their details as promoters of the product. In one embodiment, if a recipient of a copy of a content record cannot at one time contact the Registry, certain information can be stored and attempts to contact the Registry can be made at a later date.

In accordance with another important aspect of the invention, preferably included with each copy of a content record is replication software that allows recipients thereof to make copies of the content record to distribute to peers. As noted above, any copy of a content record would preferably be different from the original in several ways:
1. The copy will contain a new serial number identifying the new copy. The serial number will be different from all other copies of a content record in existence.
2. Any copy would preferably contain a record of who has copied a content record in the past, including any identification, demographic, and marketing information as well as the information on when they copied a content record. This would preferably include the current user and the information for the current copy.
3. The content contained in the content record may be changed from time to time to reflect updated material that is downloaded from the Server. The replication software may poll the Server and update the marketing material if needed.

Recipients of content in accordance with the system and method of the present invention preferably distributes a content record to peers by means specified in the instructions in the content record itself. Such instructions preferably include information and/or recommendations as to whom the content record should be further distributed.

The recipient of an instance of a content record preferably is encouraged to perpetuate the distribution process as described above.

Each instance of a content record preferably communicates with the Registry via a network to register the user of each given instance and its corresponding information. The content record may prompt the user to enter identification information (name and email, for example) as well as other demographic and marketing data (age, sex, marketing preferences). Exact information requested can depend on the particular configuration of an individual content record. In some cases, information about the user may not be collected explicitly (for example, the IP address or serial number of the client machine may be obtained without user input). This user data will be sent to the Registry and recorded there to track the user base of the content record. The ID of particular instance of the content record may also be sent to the Registry. If the Registry is unreachable, the content record can store this user information locally and attempt to contact the Registry at a later time. In addition to identification information, user activities can also be sent to the Registry, including, for example, information about any transfers that a user makes. Other user activity which may have distributing, marketing, or promotional value may also be sent to the Registry. In the case that more than a single user contacts the Registry with the same instance of the content record, appropriate information and transfer activities can be kept separate in the Registry. The Registry preferably also provides the ability for the content record to obtain information about the user base and distribution history that may be of interest to the user—for example, how many transfers have been made, the location of other users or nearby users, the number of transfers made by descendants of the current instance, etc . . . .

In one embodiment, a content record includes promotional media and news (audio content, video clips, news updates, product/brand information) integrated with CD burning software packaged on a CD for distribution. The user can view the promotional material on a computer and then register as a promoter with the Registry (inputting name, email address, and demographic information). The Promo can communicate via a network with the Registry. The user will then be able to copy a CD using integrated point-and-click software to produce instances for friends. Such a user will distribute these copies to friends who can potentially repeat the process. The content may be updated after some period of time to include newer and/or more relevant content. In addition, content may be targeted based on a user's demographic profiles or user activity patterns.

Another variation includes the packaging of promotional software (such as computer games, financial tools, and the like) on the content record. A user might be enabled to review software and pass it on freely to friends. The content record may include means for purchasing an alternative (i.e., more fully enabled) version of the software if the user chooses.

Another potential variation would be an enhanced CD. This would include an audio portion on a CD which may be played on a regular audio CD player as well as a data portion which can be accessed via a computer. The content record may then be able to provide audio content only on a larger number of devices as well as the full functionality of the data portion on a computer.

Still another variation of the invention includes governmental or political information to be disseminated in a ‘grassroots’ manner. This may include information about current law or proposed law or policy. The information could then be distributed as content by anyone who has an interest in the issues.

An Illustrative Implementation of the Invention

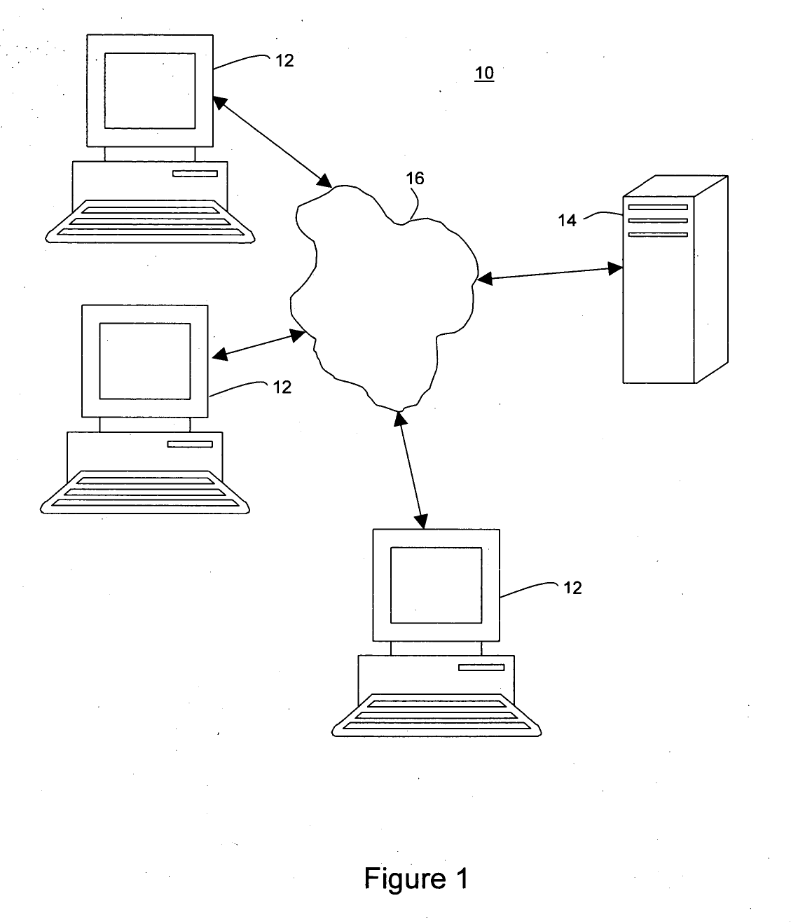

Referring to FIG. 1, there is shown a network infrastructure 10 upon which the present invention may be practiced. As shown in FIG. 1, the underlying infrastructure or system 10 includes at least one “client” computer 12 which is interconnected with at least one host computer 14 by means of an interconnecting network 16, which may be, in a preferred embodiment and for example, what is commonly referred to and understood to comprise the Internet, the global interconnection of computer networks familiar to those of ordinary skill in the art.

A promotional/distribution process takes place within infrastructure 10 as follows: First, some number (one or more) of copies of content is provided to users. In one embodiment, the content may be audio files, for example, demonstration cuts (demos) from a musical work. The recipients of the content may be a targeted group of individuals who are identified as being likely to appreciate the content and motivated to share it with others. Such a scenario plays itself out frequently in the music industry as a method of generating interest in and awareness of a musical group's works. The initial recipients in such instances are sometimes referred to as “street teams” or “starting fans.”

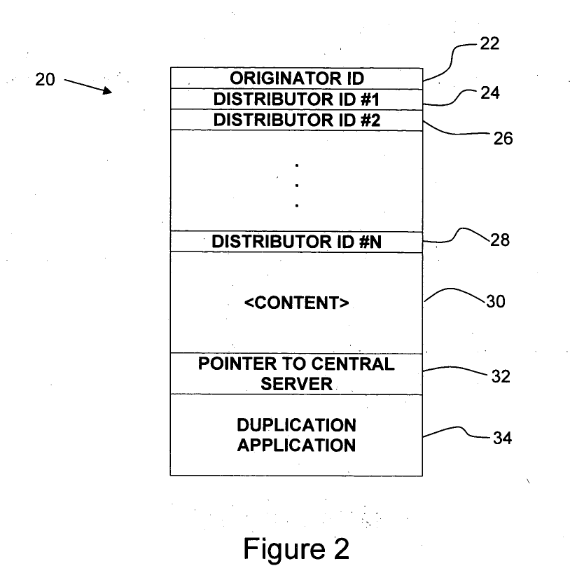

In the preferred embodiment, the content is supplied to recipients in a format that includes, in addition to the content itself, certain other information, as depicted in FIG. 2. As shown in FIG. 2, and in accordance with one aspect of the invention, a content record 20 has associated therewith certain tracer information, including, for example, an identification of the originator of the content (originator ID 22), and preferably identifying information regarding each subsequent recipient of a copy of the content record 20 who in turn duplicates and distributes copies of the content record 20 to others (distributor IDs 24, 26, and 28 in the exemplary embodiment of FIG. 2).

For example, a music publishing company may issue copies of demos from a particular musical artist/group to a targeted “street team” with the objective of generating interest and awareness of the artist/group. The content records comprising the demos may be in the form of a compact disk (CD), for example. In addition to content playable on a conventional CD audio player, each demo CD initially includes an originator ID 22 identifying the music publishing company as the originator of the content record 20. It is to be noted that the original copies of content records 20 may be distributed by means other than physical distribution of CDs. For example, the original content records may be made available to users 12 over a network 16.

Also included as part of each content record is preferably a pointer 32 or other identifying information for directing the recipient of a copy of the content record to contact central server 14. The pointer 32 may be included as a text file or Internet hyperlink, or could simply be an Internet address physically imprinted upon the distribution media.

In one embodiment of the invention, each copy of a content record 20 also has associated therewith an application for facilitating duplication of the content record 20 in a manner which propagates and adds to the information contained in content record 20. In one embodiment, a recipient of a content record may be prompted to execute the duplication application each time the user wishes to make a copy for distribution to others.

Preferably, execution of the duplication application will involve, in instances where a recipient's system 12 is capable of accessing central server 14 via network 16, involves contacting central server 14 to “register” the copy being made. During such a registration process, several significant steps can occur. First, the recipient making the copy can be prompted to enter selected personal data, such as name, address, age, gender, content preferences, and so on, and this information can be communicated to central server 14 for compilation in a database. This information can be valuable to originators of content, inasmuch as it can reveal the extent of distribution of the content and the demographics of those who are using and further distributing the content.

In addition, the registration process can optionally involve updating or modifying the content before further copies of the content record are made. In the case of music demos, for example, the music publisher may elect to change the selection of content provided based upon updated information regarding the popularity of individual works, for example.

Additionally, the registration process provides the opportunity for content originators to reward recipients for participating in the distribution process. For example, the central server might be programmed to respond keep track of the number of copies of a content record a particular recipient has made, and to provide additional content to that recipient after a certain number is reached. In this way, those recipients who are especially prolific in distributing content can be rewarded in some manner, be it with additional content that is not provided to those less prolific in distribution, or in some other fashion.

The opportunity to alter or modify the content of a content record upon registration of a given copy with central server 14 provides the additional advantage of enabling content originators to adapt their promotional strategy on an ongoing basis. Continuing to use the example of audio/music content, a content originator (i.e., music publisher) may determine that the demographics of one group of recipients of a particular content record has displayed an affinity or preference for another content record as well. Recognizing this, the central server can add to or change the content of a content record for subsequent recipients of copies of the content record.

Of course, not all recipients of a copy of a content record will necessarily be able to or willing to register their copy with central server 14. For example, a recipient may access the content and make copies of the content record on a computer or other system that is not connected to a network 16 (e.g., the Internet). In such cases, the “pedigree” of that user's copy, that is, the record of originator ID 22 and distributor IDs, of the content record can nevertheless be updated should the user utilize the duplication application 34 to create a copy of the content record. That is to say, registration of a particular copy of a content record, though encouraged, is not compulsory.

In an instance where a duplicate of a content record 20 is made without registration with a central server 14 and that duplicate is shared (distributed) to another, the duplicate will still contain tracer information regarding the duplicator of the content record. Should the duplicate copy be registered with central server 14 at a later time, the information regarding the intervening non-registering copier(s) can at that time be provided to central server 14 to “fill in the gaps” in information regarding the chain of distribution from originator through intervening distributors.

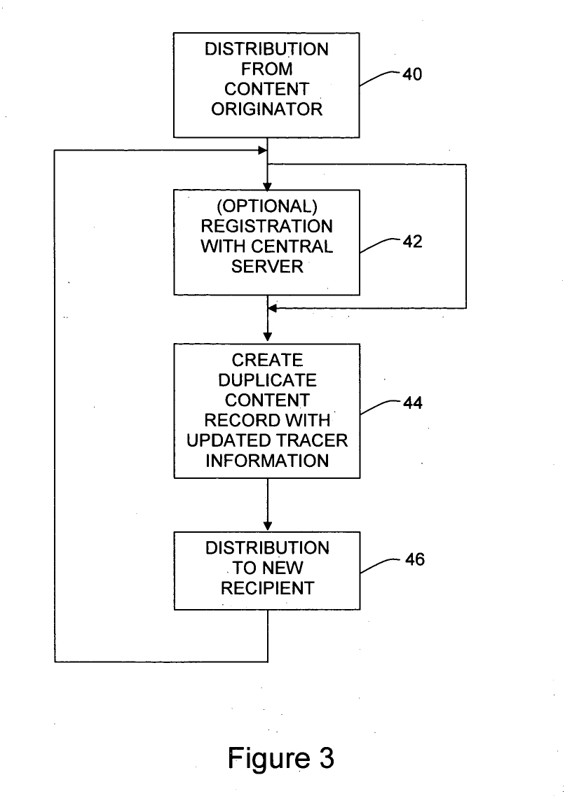

The distribution process for content records in accordance with one embodiment of the invention is diagrammatically illustrated in FIG. 3. A first step 40 in the process is, of course, distribution of an original content record. As noted above, this distribution process can involve physical distribution of storage media containing the content record (e.g., a CD or CD-ROM), or alternatively may involve providing one or more copies over network 16. Each original content record preferably identifies the originator of the content in originator ID field 22 (see FIG. 2).

Each recipient of an original content record 20 is then free to register the content record 20, as reflected in step 42 in FIG. 3. As noted above and as is reflected in FIG. 3, registration step 42 may be considered optional on the part of each recipient. Each recipient of a content record is also free to create a duplicate (copy) of the content record for distribution to others, as reflected in step 44 in FIG. 3. As described above, duplication of a content record 20 is preferably accomplished using a duplication application associated with the content record, such that appropriate data in the content record 20 can be updated. First and foremost, the content record 20 is preferably updated to uniquely identify the copy being made, in one of the distributor ID fields previously discussed with reference to FIG. 2. The content record can be updated to incorporate essentially any data desired, including date data, geographic information, demographic information (to the extent that such data can be solicited from the recipient making the copy), and so on. In general, this collection of information is referred to herein as “tracer” information.

Once a copy of a content record is made, the copying recipient may then choose to distribute (share) that copy with another. This is represented in block 46 in FIG. 3. Thereafter, the distribution process begins anew, with the new recipient being free to register his or her copy (block 42), make further copies with updated tracer information (block,44), and distribute those copies to still further recipients (block 46).

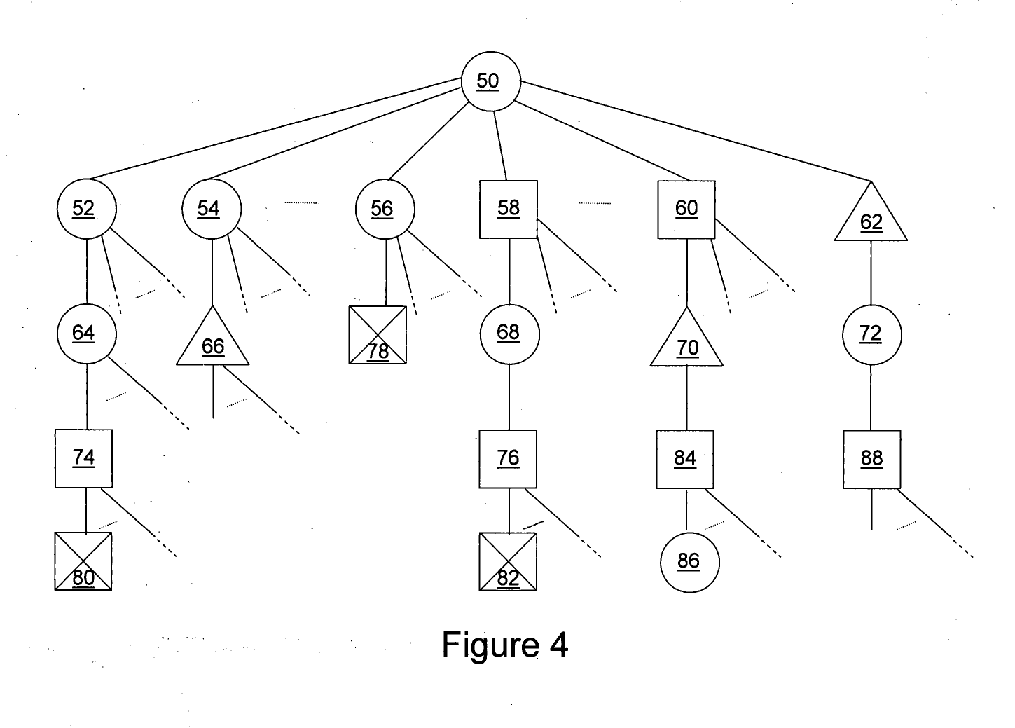

Turning now to FIG. 4, there is shown a diagram of a portion of a distribution map, or “Promo” realized in accordance with one embodiment of the invention. It is believed that the diagram of FIG. 4 is useful in illustrating the operation of the present invention and to clarify the terminology used herein to describe the distribution of content in accordance with the particulars of the invention.

In the diagram of FIG. 4, different shapes are used to represent instances or copies of a content record 20. The different shapes represent the different manners in which a recipient of the instance thusly represented processes the instance/copy that the recipient receives.

Specifically, a round instance in FIG. 4 (e.g., instance 50) represents an instance or copy of a content record 20 whose recipient communicates and registers with central server 14 upon generation of a copy, thereby causing the identifying information for that copy to reflect the fullest possible ancestry of that copy, including the Originator ID 22 and subsequent distributor IDs for distributors who similarly took the steps necessary to register the copies that they (subsequent distributors) made before the recipient received the represented instance.

On the other hand, a “square” instance in FIG. 4 (e.g., instance 58) represents an instance or copy of a content record 20 whose recipient uses the duplication application 34 associated with the copy that the recipient received to make additional instances/copies for distribution to others, but who does not (or cannot) take the steps necessary to contact central server 14 to register the copy that the recipient received or to notify central server of the copies the recipient makes for further distribution. The distinction between an instance/copy of a content record 20 represented by a round instance in FIG. 4 and a content record 20 represented by a square instance in FIG. 4 is that copies promulgated from a “round” instance, i.e, descendants of the round instance, will reflect any changes to the content record 20 specified by the content server which may have occurred since the previously registered copy in the ancestry of the copy in question was made.

A triangular instance in FIG. 4 (e.g., instance 62) represents an instance or copy of a content record 20 whose recipient generates further instances of the content record 20 by means where the recipient neither registers the received instance of content record: 20, nor invokes duplication application 34 to update the ancestral identifying information of the content record. This situation is considered in recognition of the possibility that the medium of transmission of a given instance of a content record 20 may admit to duplication by means not reliant upon duplication application 34, and therefore not guaranteed to include any modification of the tracing and ancestral information preferably associated with instances of a content record 20 at any particular generation.

Normally, a “Promo” or distribution process commences with an originator creating a first instance of a content record and distributing it to one or more recipients. In accordance with the presently disclosed embodiment, such a first instance would includes identifying information specific to the originator, i.e., Originator ID 22, as discussed above with reference to FIG. 2.

In the diagram of FIG. 4, instance 50 could be considered to be the “original” instance of the digital content, in which case it would be expected that every “child” instance emanating from instance 50 would be expected to be a “round” instance, i.e., one which includes ancestral identifying information including information about the originator. However, for illustrative purposes, FIG. 4 is intended to represent a more generic situation, in which instance 50 represents an instance at an arbitrary point along the ancestral line of an instance of a content record.

In the purely exemplary embodiment of FIG. 4, the recipient of instance 50 generates several instances or copies of content record 20, namely “round” instances 52, 54, and 56. In the cases of instances 52, 54, and 56, FIG. 4 indicates that the recipient of each of those instances 50 invoked duplication application 34 to create instances (copies) thereof, and further established communication with central server 14 to register instances 52, 54, and 56 with central server 14. In each of these cases, instances 52, 54, and 56 would contain unique tracing information specific to the recipient of instance 50, along with any unique tracing information specific to the source/generator of instance 50. Also, since instance 50 was registered, the content of instances 52, 54, and 56 can reflect changes specified by central server since instance 50 was created.

In the embodiment of FIG. 4, the recipient of instance 50 also generates one or more instances or copies of content record 20, namely “square” instances 58 and 60. As shown in FIG. 4, instances 58 and 60, in turn, create instances 68 and 70, respectively, using duplication application 34 but without registering instances 58 and 60 prior to creating those copies. In the cases of instance 68 therefore, the tracing information will include unique identifiers of instances 50 and 58, but the content of instance 68 will be unchanged relative to instance 58. Likewise, the tracing information for instance 70 will include unique identifiers of instances 60 and 50, but the content of instance 70 will be unchanged relative to instance 60.

Finally, it must be recognized that depending upon the nature of the content and the media upon which a given instance of a content record is stored, it may be possible for a recipient to create an instance of the content record without invoking duplication application 34, and thereby not updating the tracer information as called for in accordance with the invention. In the hypothetical example of FIG. 4, the recipient of instance 62 utilizes means other than duplication application 34 to create instance 72. Accordingly, the tracer information in instance 72 will not reflect the existence of instance 62, but will uniquely identify only instance 50.

With continued reference to FIG. 4, instance 64, which was created by instance 52, will include unique identifiers for instances 52 and 50. Since instance 64 is a “round” instance, indicating that its recipient both invoked duplication application 34 and registered with central server 14, such that instance 74 will include unique identifiers (and possibly other information, as discussed above) for instances 64, 52, and 50. Instance 74 is a “square” instance indicating that it is not registered with central server 14 but that the recipient of instance 74 invokes duplication application 34 to create instance 80. Consequently, instance 80 will contain the tracer information for instances 74, 64, 52, and 50.

The following tables summarize the ancestral information associated with each instance depicted in FIG. 4. In each case, an asterisk (*) denotes an instance whose content may be modified relative to its parent as a result of the parent instance having been registered with central server 14.

```
INSTANCE 52*
Instance 50
INSTANCE 64*
Instance 50
  Instance 52*
INSTANCE 74*
Instance 50
  Instance 52*
  Instance 64*
INSTANCE 80
Instance 50
  Instance 52*
  Instance 64*
  Instance 74*
INSTANCE 54*
Instance 50
INSTANCE 66*
Instance 50
  Instance 54*
INSTANCE 56*
Instance 50
INSTANCE 78*
Instance 50
  Instance 56*
INSTANCE 58*
Instance 50
INSTANCE 68
Instance 50
  Instance 58*
INSTANCE 76*
Instance 50
  Instance 58*
Instance 68
INSTANCE 82
Instance 50
  Instance 58*
Instance 68
  Instance 76*
INSTANCE 60*
Instance 50
INSTANCE 70
Instance 50
  Instance 60*
INSTANCE 84
Instance 50
  Instance 60*
INSTANCE 86
Instance 50
  Instance 60*
Instance 84
INSTANCE 62*
Instance 50
INSTANCE 72
Instance 50
INSTANCE 88*
Instance 50
Instance 72
```

In the foregoing tables, the table header identifies an instance of the content record, and the entries in a given table represent the ancestors of that instance, e.g., parent, grand-parent, great-grandparent, and so on. Collectively, each table thus constitutes the “lineage” or “ancestral history” of the instance in question. It is to be noted that depending upon the behavior of any given ancestor of an instance, the ancestral history represented each table may be only partial. For example, to the extent that a given instance has an ancestor who created a copy of the content record without invoking distribution application 34, that ancestor will not be identified in the ancestral history. Each ancestral history should be at least partially complete, however, given that the original (parent) instance of the content record will uniquely identify itself at a minimum.

From the foregoing description of one or more particular implementations of the invention, it should be apparent that a system and method for distribution of digital content has been disclosed which offers significant advantages over present distribution methodologies. Although a broad range of implementation details have been discussed herein, these are not to be taken as limitations as to the range and scope of the present invention as defined by the appended claims. A broad range of implementation-specific variations and alterations from the disclosed embodiments, whether or not specifically mentioned herein, may be practiced without departing from the spirit and scope of the invention as defined in the appended claims.

It is especially noted that although one preferred embodiment of the invention is disclosed herein in the context of distribution of “demos” of music and performing artists' works, the invention is by no means limited to this particular application.

1. A method of distributing digital content to a recipient base, comprising:
(a) originating a parent instance of said digital content and generating at least one child instance thereof for distribution to at least one recipient, said at least one child instance including identifying information specific to itself and said parent instance;
(b) generating at least one child instance of its parent instance and to distribute said at least one child instance to at least one recipient, each child instance including identifying information specific to itself and one or more ancestor instances thereof, said step (b) being performed by said at least one recipient;
(c) repeating step (b) indefinitely, such that each child instance generated incorporates identifying information specific to a progressively growing ancestral history of copies.

2. A method in accordance with claim 1, wherein each instance of said digital content comprises a content record including said digital content and said identifying information.

3. A method in accordance with claim 2, wherein each content record further comprises a duplication application for performing said step (b) of generating at least one child instance of said digital content.

4. A method in accordance with claim 3, wherein said duplication application performs a further step (d) of updating said identifying information to include information uniquely identifying the instance from which said duplication application was invoked.

5. A method in accordance with claim 4, wherein said duplication application optionally performs a further step (e) of contacting a remote central server to register the instance from which said duplication application was invoked.

6. A method in accordance with claim 5, wherein said step (e) of contacting a remote central server comprises contacting said remote central server via a network.

7. A method in accordance with claim 6, wherein said network comprises the Internet.

8. A method in accordance with claim 5, wherein said step (e) of registering the instance comprises communicating said identifying information from the instance from which said duplication application was invoked.

9. A method in accordance with claim 6, wherein said distribution application performs a further step (f) of replacing said digital content included in said content record with updated digital content received from said central server.

10. A method in accordance with claim 4, wherein said duplication application optionally performs a further step (g) of prompting a recipient to add information to said identifying information in said content record.

11. A method in accordance with claim 10, wherein said added information includes selected demographic information relating to said recipient.

12. A method in accordance with claim 1, wherein said identifying information further includes selected demographic information relating to said recipient.
